(19) United States
(12) Patent Application Publication
(10) Pub. No.: US 2022/0311574 A1
(43) Pub. Date: Sep. 29, 2022

(54) DMRS CONFIGURATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/413,255

(22) PCT Filed: Dec. 14, 2018
(86) PCT No.: PCT/CN2018/121172

§ 371 Date: Jun. 11, 2021

(51) Int. Cl. H04L 5/00; H04W 72/04

(52) U.S. Cl. CPC H04L 5/0048; H04W 72/042

(57) ABSTRACT

Embodiments of the present disclosure provide methods, devices and computer readable media for Demodulation Reference Signal (DMRS) configuration. In example embodiments, a method implemented at a terminal device is provided. The method comprises receiving downlink control information (DCI) from at least one of a plurality of Transmission and Reception Points (TRPs) in communication with the terminal device, the plurality of TRPs being associated with different reference signal (RS) sets. The method further comprises determining, from the DCI, a configuration for Demodulation Reference Signal (DMRS) transmission between the plurality of TRPs and the terminal device. The configuration at least indicates one or more DMRS ports from a first number of DMRS CDM groups to be used for the DMRS transmission and respective numbers of DMRS CDM groups associated with the different RS sets. In this way, multi-user scheduling is enabled for multi-TRP transmission. Moreover, interference cancellation can be achieved more accurately.

### TECHNICAL FIELD

Embodiments of the present disclosure generally relate to wireless communication, and in particular, to methods, devices and computer readable media for Demodulation Reference Signal (DMRS) configuration.

### BACKGROUND

With the development of communication technologies, multiple types of services or traffic have been proposed, for example, enhanced mobile broadband (eMBB) generally requiring high data rate, massive machine type communication (mMTC) typically requiring long battery lifetime, and ultra-reliable and low latency communication (URLLC). Meanwhile, multi-antenna schemes, such as multi-Transmission and Reception Point (multi-TRP) transmission and/or multi-panel transmission, are studied for new radio access (NR).

Conventionally, a network device (for example, an eNB or a gNB) transmits a downlink DMRS to a terminal device (for example, a user equipment) in the system for channel demodulation. The terminal device may receive the downlink DMRS on allocated resources. The terminal device may also transmit an uplink DMRS to the network device on corresponding allocated resources. For indicating the allocated resources and other necessary information for the DMRS transmission, the network device may transmit DMRS configurations to the terminal device prior to the transmissions of the DMRSs. One or more DMRS tables used for indication of different DMRS configurations have been specified in current 3GPP specifications. However, there tables are typically designed for single TRP transmission, in which the support for multi-user scheduling or interference cancelling is insufficient.

### SUMMARY

In general, example embodiments of the present disclosure provide methods, devices and computer readable media for DMRS configuration.

In a first aspect, there is provided a method implemented at a terminal device. The method comprises: receiving downlink control information (DCI) from at least one of a plurality of Transmission and Reception Points (TRPs) in communication with the terminal device, the plurality of TRPs being associated with different reference signal (RS) sets; and determining, from the DCI, a configuration for Demodulation Reference Signal (DMRS) transmission between the plurality of TRPs and the terminal device, wherein the configuration at least indicates one or more DMRS ports from a first number of DMRS CDM groups to be used for the DMRS transmission and respective numbers of DMRS CDM groups associated with the different RS sets.

In a second aspect, there is provided a method implemented at a network device. The method comprises: determining a configuration for Demodulation Reference Signal (DMRS) transmission between a terminal device served by the network device and a plurality of Transmission and Reception Points (TRPs) in communication with the terminal device, wherein the plurality of TRPs are associated with different reference signal (RS) sets, and the configuration at least indicates one or more DMRS ports from a first number of DMRS CDM groups to be used for the DMRS transmission and respective numbers of DMRS CDM groups associated with the different RS sets; generating downlink control information (DCI) indicating the configuration; and transmitting the DCI to the terminal device via at least one of the plurality of TRPs.

In a third aspect, there is provided a terminal device. The terminal device comprises a processor and a memory coupled to the processor. The memory stores instructions that when executed by the processor, cause the terminal device to perform actions. The actions comprise: receiving downlink control information (DCI) from at least one of a plurality of Transmission and Reception Points (TRPs) in communication with the terminal device, the plurality of TRPs being associated with different reference signal (RS) sets; and determining, from the DCI, a configuration for Demodulation Reference Signal (DMRS) transmission between the plurality of TRPs and the terminal device, wherein the configuration at least indicates one or more DMRS ports from a first number of DMRS CDM groups to be used for the DMRS transmission and respective numbers of DMRS CDM groups associated with the different RS sets.

In a fourth aspect, there is provided a network device. The network device comprises a processor and a memory coupled to the processor. The memory stores instructions that when executed by the processor, cause the network device to perform actions. The actions comprise: determining a configuration for Demodulation Reference Signal (DMRS) transmission between a terminal device served by the network device and a plurality of Transmission and Reception Points (TRPs) in communication with the terminal device, wherein the plurality of TRPs are associated with different reference signal (RS) sets, and the configuration at least indicates one or more DMRS ports from a first number of DMRS CDM groups to be used for the DMRS transmission and respective numbers of DMRS CDM groups associated with the different RS sets; generating downlink control information (DCI) indicating the configuration; and transmitting the DCI to the terminal device via at least one of the plurality of TRPs.

In a fifth aspect, there is provided a computer readable medium having instructions stored thereon. The instructions, when executed on at least one processor, cause the at least one processor to carry out the method according to the first aspect of the present disclosure.

In a sixth aspect, there is provided a computer readable medium having instructions stored thereon. The instructions, when executed on at least one processor, cause the at least one processor to carry out the method according to the second aspect of the present disclosure.

In a seventh aspect, there is provided a computer program product that is tangibly stored on a computer readable storage medium. The computer program product includes instructions which, when executed on at least one processor, cause the at least one processor to carry out the method according to the first aspect or the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIGS. 1A-1B show an example communication network in which embodiments of the present disclosure can be implemented;

FIGS. 2A-2D shows diagrams of configuration patterns for different DMRS types according to some embodiments of the present disclosure;

FIG. 3 shows a diagram of an example scenario of multi-TRP transmission;

FIG. 4 shows a signaling interaction diagram of a process for DMRS configuration according to some implementations of the present disclosure;

FIGS. 5A-5B show an example of DMRS configuration for DMRS type 1 according to some implementations of the present disclosure;

FIGS. 6A-6C show an example of DMRS configuration for DMRS type 2 according to some implementations of the present disclosure;

FIGS. 7A-7B show an example of DMRS configuration for DMRS type 2 according to some implementations of the present disclosure;

FIG. 8 shows a flowchart of an example method for DMRS configuration according to some embodiments of the present disclosure;

FIG. 9 shows a flowchart of an example method for DMRS configuration according to some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

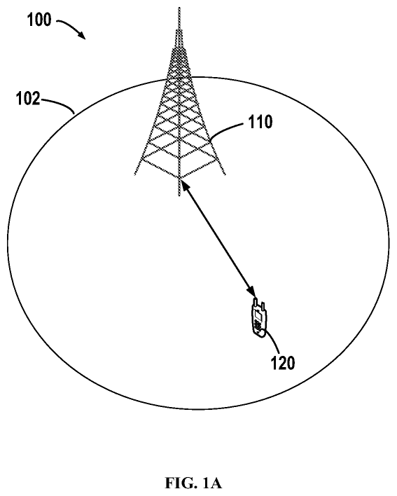

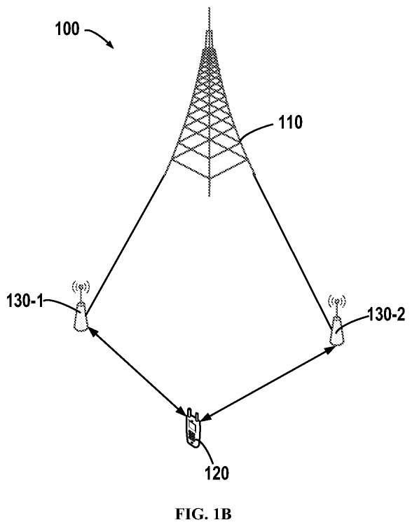

FIG. 1A shows an example communication network 100 in which embodiments of the present disclosure can be implemented. The network 100 includes a network device 110 and a terminal device 120 served by the network device 110. The network 100 may provide one or more serving cells 102 to serve the terminal device 120. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 220.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device 110.

In the communication network 100 as shown in FIG. 1A, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 (such as, a gNB) may be equipped with one or more TRPs or antenna panels. As used herein, the term ‘TRP’ refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements) or a group of antennas. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

FIG. 1B shows an example scenario of the network 100 as shown in FIG. 1A. As shown in FIG. 1B, for example, the network device 110 may communicate with the terminal device 120 via the TRPs 130-1 and 130-2 (collectively referred to as “TRPs 130” or individually referred to as “TRP 130”). The first and second TRPs 130-1 and 130-2 may be included in a same serving cell (such as, the cell 102 as shown in FIG. 1A) or different serving cells provided by the network device 110.

In the network 100 as shown in FIGS. 1A and 1B, a demodulation reference signal (DMRS) may be a type of reference signal that provides modulation/demodulation information related to a communication channel for accurate or coherent decoding of information transmitted via the communication channel.

Prior to the UL or DL DMRS transmission, the network device 110 may allocate corresponding resources (also referred to as “DMRS resources”) for DMRS transmission and/or specify which DMRS sequence is to be transmitted. In some scenarios, both the network device 110 and the terminal device 120 are equipped with multiple antenna ports and can transmit specified RS sequences with the antenna ports. A set of DMRS resources associated with a number of DMRS ports are also specified. A DMRS port may be referred to as a specific mapping of part or all of a DMRS sequence to one or more resource elements (REs) of a resource region allocated for RS transmission in time, frequency, and/or code domains. In NR, different DMRS ports may be multiplexed based on Code Division Multiplexing (CDM) technology in time and/or frequency domain, and/or based on Frequency Division Multiplexing (FDM) technology. For example, a group of DMRS ports may also referred to as a “DMRS port group” or “DMRS group”. A group of DMRS ports multiplexed based on CDM technology can also be referred as a “CDM group”.

In some embodiments, such resource allocation information as well as other necessary information may be indicated to the terminal device 120 prior to the transmission of the DMRSs. For example, the DMRS configurations can be transmitted via higher layer signaling (such as Radio Resource Control (RRC) and/or Medium Access Control (MAC) Control Element (CE)) and/or dynamic signaling (such as downlink control information (DCI)) to the terminal device.

In some embodiments, a number of codewords may be configured for the terminal device 120. For example, the number may be 1 or 2. For example, the number of codewords may be configured by signaling in Radio Resource Control (RRC) and/or Medium Access Control (MAC) and/or Physical Layer (PHY).

In some embodiments, a set of parameters for DMRS configuration may be configured for the terminal device 120. The set of parameters may include at least one of the maximum number/length of the symbols for DMRS, a type of DMRS, and etc. For example, the set of parameters may be configured by signaling in Radio Resource Control (RRC) and/or Medium Access Control (MAC) and/or Physical Layer (PHY).

In some embodiments, the maximum number/length (for example, the maximum number/length is M) of symbols for DMRS may be the maximum number of symbols for each DMRS transmission occasion in one PDSCH transmission duration, and one DMRS transmission occasion may be the DMRS transmission in K consecutive symbols. For example, M may be 1, 2, 3 or 4. For example, K may be 1, 2, 3 or 4, and K is no greater than M. In some embodiments, the maximum number/length (for example, the maximum number/length is M) of symbols for DMRS may be the maximum number of symbols for the front-loaded DMRS, where the front-loaded DMRS is the first DMRS transmission occasion in K consecutive symbols in one PDSCH transmission duration. For example, M may be 1, 2, 3 or 4. For example, K may be 1, 2, 3 or 4, and K is no greater than M.

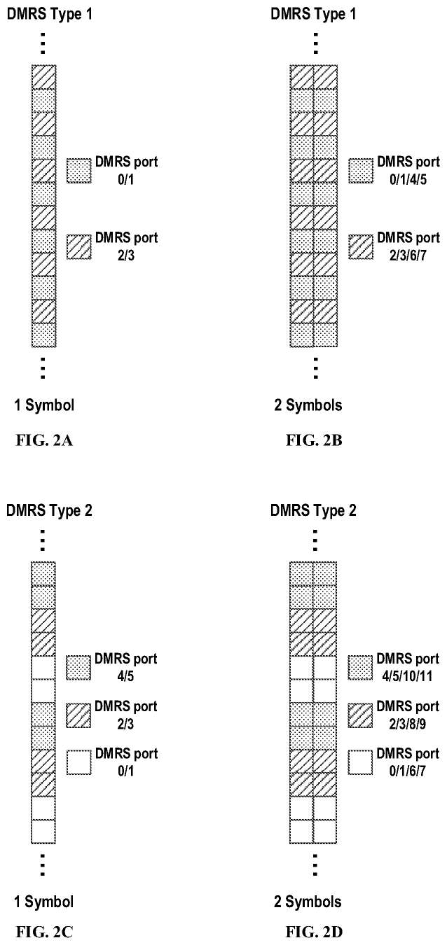

In some embodiments, the type of DMRS may refer to the DMRS configuration pattern in time and/or frequency domain. There are up to two types of DMRS can be configured for a terminal device (for example, DMRS type 1 and/or DMRS type 2). FIGS. 2A-2D shows configuration patterns of the two different DMRS types. For DMRS type 1, one or two symbols can be supported. As shown in FIG. 2A, for DMRS type 1 associated with one symbol, up to 4 DMRS ports (represented as DMRS ports {0, 1, 2, 3}) can be supported. As shown in FIG. 2B, for DMRS type 1 associated with two symbols, up to 8 DMRS ports (represented as DMRS ports {0, 1, 2, 3, 4, 5, 6, 7}) can be supported. For example, for DMRS type 1, there may be up to two CDM groups. One CDM group may occupy REs with even indices within one RB including 12 REs, for example, REs 0, 2, 4, 6, 8 and 10, where the RE index starts from 0. The other CDM group may occupy REs with odd indices within one RB, for example, REs 1, 3, 5, 7, 9 and 11, where the RE index starts from 0. For DMRS type 2, one or two symbols can be supported. As shown in FIG. 2C, for DMRS type 2 associated with one symbol, up to 6 DMRS ports (represented as DMRS ports {0, 1, 2, 3, 4, 5}) can be supported. As shown in FIG. 2D, for DMRS type 2 associated with two symbols, up to 12 DMRS ports (represented as DMRS ports {0, 1, 2, 3, 4, 5, 6, 7, 8, 9, 10, 11}) can be supported. For example, for DMRS type 2, there may be up to three CDM groups. One CDM group may occupy REs 0, 1, 6 and 7; one CDM group may occupy REs 2, 3, 8 and 9; and one CDM group may occupy REs 4, 5, 10 and 11, where the RE index starts from 0. In FIGS. 2A-2D, different fill patterns may represent different CDM groups.

In some embodiments, as an example of grouping of the DMRS ports, for DMRS type 1 as defined in 3GPP specifications, up to 2 DMRS groups (DMRS group G1 and/or DMRS group G2) may be configured. For example, if two DMRS groups are configured, DMRS group G1 may include at least one DMRS port from {0,1,4,5}, and DMRS group G2 may include at least one DMRS port from {2,3,6,7}. As another example, if only one DMRS group is configured, there is only one DMRS group G1 or DMRS group G2, and DMRS group G1 or DMRS group G2 may include at least one DMRS port from {0,1,2,3,4,5,6,7}.

In some embodiments, as an example of grouping of the DMRS ports, for DMRS type 2 as defined in 3GPP specifications, up to 2 DMRS groups (DMRS group G1 and/or DMRS group G2) may be configured. For example, if two DMRS groups are configured, DMRS group G1 may include at least one DMRS port from {0,1,6,7, 4,5,10,11}, and DMRS group G2 may include at least one DMRS port from {2,3,8,9}. As another example, if two DMRS groups are configured, DMRS group G1 may include at least one DMRS port from {0,1,6,7}, and DMRS group G2 may include at least one DMRS port from {2,3,8,9, 4,5,10,11}. As another example, if two DMRS groups are configured, DMRS group G1 may include at least one DMRS port from {0,1,6,7,2,3,8,9}, and DMRS group G2 may include at least one DMRS port from {4,5,10,11}. As another example, if only one DMRS group is configured, there is only one DMRS group G1 or DMRS group G2, and DMRS group G1 or DMRS group G2 may include at least one DMRS port from {0,1,2,3,4,5,6,7,8,9,10,11}.

In some embodiments, as an example of grouping of the DMRS ports, for DMRS type 2 as defined in 3GPP specifications, three DMRS groups (DMRS group G1, DMRS group G2, and DMRS group G3) may be configured. For example, if three DMRS groups are configured, DMRS group G1 may include at least one DMRS port from {0,1,6,7}, DMRS group G2 may include at least one DMRS port from {2,3,8,9}, and DMRS group G3 may include at least one DMRS port from {4,5,10,11}.

In some embodiments, the terminal device 120 may be configured with a DMRS type and/or a maximum number/length of DMRS and/or the number of codewords. If the terminal device 120 is configured with a given DMRS type, a given value of the maximum number/length of DMRS, and a given value of the number of codewords, there is one corresponding table for indication of at least one of antenna ports, the number of DMRS CDM group(s) without data, the number of front-loaded DMRS symbols, the number of DMRS port(s), and respective indices for the DMRS port(s).

As described above, prior to transmission of DMRSs, the network device may transmit DMRS configurations to a terminal device for indicating the allocated resources and other necessary information for the DMRS transmission. One or more DMRS tables used for indication of different DMRS configurations have been specified in current 3GPP specifications. However, there tables are typically designed for single TRP transmission, in which the support for multi-user scheduling or interference cancelling is insufficient.

For example, in current specifications, it has been specified that, for DMRS type 1, if a terminal device is scheduled with one codeword and assigned with the antenna port mapping with indices of {2, 9, 10, 11 or 30} in Table 1 as below, or if the terminal device is scheduled with two codewords, the terminal device may assume that all of the remaining orthogonal antenna ports are not associated with transmission of Physical Downlink Shared Channel (PDSCH) to another terminal device.

TABLE 1

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS | | Number of | | DMRS | | Number of |
| | CDM group(s) | DMRS | front-load | | CDM group(s) | DMRS | front-load |
| Value | without data | port(s) | symbols | Value | without data | port(s) | symbols |
| 2 | 1 | 0, 1 | 1 | 0 | 2 | 0-4 | 2 |
| 9 | 2 | 0-2 | 1 | 1 | 2 | 0, 1, 2, 3, 4, 6 | 2 |
| 10 | 2 | 0-3 | 1 | 2 | 2 | 0, 1, 2, 3, 4, 5, 6 | 2 |
| 11 | 2 | 0, 2 | 1 | 3 | 2 | 0, 1, 2, 3, 4, 5, 6, 7 | 2 |
| 30 | 2 | 0, 2, 4, 6 | 2 | | | | |

For DMRS type 2, if a terminal device is scheduled with one codeword and assigned with the antenna port mapping with indices of {2, 10 or 23} in Table 2 as below, or if the terminal device is scheduled with two codewords, the terminal device may assume that all of the remaining orthogonal antenna ports are not associated with transmission of PDSCH to another terminal device.

TABLE 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS | | Number of | | DMRS | | Number of |
| | CDM group(s) | DMRS | front-load | | CDM group(s) | DMRS | front-load |
| Value | without data | port(s) | symbols | Value | without data | port(s) | symbols |
| 2 | 1 | 0, 1 | 1 | 0 | 3 | 0-4 | 1 |
| 10 | 2 | 0-3 | 1 | 1 | 3 | 0-5 | 1 |
| 23 | 2 | 0, 2 | 1 | 2 | 2 | 0, 1, 2, 3, 6 | 2 |
| | | | | 3 | 2 | 0, 1, 2, 3, 6, 8 | 2 |
| | | | | 4 | 2 | 0, 1, 2, 3, 6, 7, 8 | 2 |
| | | | | 5 | 2 | 0, 1, 2, 3, 6, 7, 8, 9 | 2 |

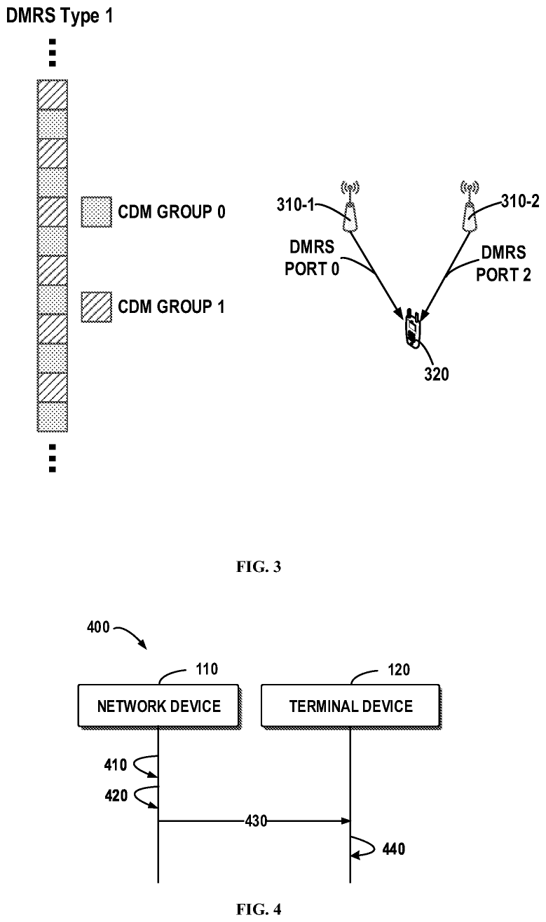

However, for multi-TRP transmission, the above assumptions may be not sufficient. For example, FIG. 3 shows an example scenario of multi-TRP transmission. In the example as shown in FIG. 3, it is assumed that DMRS type 1 and one codeword are configured. As shown in FIG. 3, two TRPs 310-1 and 310-2 communicate with a terminal device 320. The terminal device 320 is configured with DMRS ports 0 and 2 for DL DMRS transmission. For example, DMRS port 0 coming from CDM group 0 is associated with the TRP 310-1, which DMRS port 2 coming from CDM group 1 is associated with the TRP 310-2. In this event, the index of the antenna port mapping is 11 as shown above in Table 1. That is, the terminal device 320 may assume that all of other orthogonal antenna ports than DMRS ports 0 and 2 are not associated with transmission of PDSCH to another terminal device.

However, in the scenario as shown in FIG. 3, DMRS port 2 may or may not be used for DMRS transmission from the TRP 310-1 to another terminal device. If DMRS port 2 is used for DMRS transmission from the TRP 310-1 to another terminal device, the terminal device 320 may suffer from interference from the other terminal device. In addition, DMRS port 1 may or may not be used for DMRS transmission from the TRP 310-2 to another terminal device. If DMRS port 1 is used for DMRS transmission from the TRP 310-2 to another terminal device, the terminal device 320 may also suffer from interference from the other terminal device. As can be seen that, in current DMRS tables, such information has not been indicated. In this event, the terminal device 320 cannot perform interference cancellation accurately.

Embodiments of the present disclosure provide a solution for DMRS configuration. This solution enables multi-user scheduling for multi-TRP transmission. In addition, according to this solution, interference from other terminal devices can be indicated, and thus interference cancellation can be achieved more accurately.

Principles and implementations of the present disclosure will be described in detail below with reference to FIG. 4, which shows a process 400 for DMRS configuration according to some implementations of the present disclosure. For the purpose of discussion, the process 400 will be described with reference to FIG. 1B. The process 400 may involve the network device 110, the terminal device 120 and the TRPs 130 in FIG. 1B.

As shown in FIG. 4, the network device 110 determines 410 a configuration for DMRS transmission between the terminal device 120 and the TRPs 130. In some embodiments, each of the TRPs 130 may be associated with a Transmission Configuration Indication (TCI) state, which indicates Quasi-Co-Location (QCL) relationships between one or more RSs in a corresponding RS set (also referred to as “TCI RS set” or “QCL RS set”) and one or more DMRS ports in a corresponding DMRS port group. That is, each of the TRPs 130 may be associated with a respective RS set and/or a respective DMRS port group. In some embodiments, the determined configuration may indicate at least one of the following: DMRS port(s) to be used for the DMRS transmission, the number of DMRS CDM group(s) without data, the number of front-loaded DMRS symbols, respective numbers of DMRS CDM group(s) associated with different RS sets (different TRPs), the number of DMRS port(s), and respective indices for the DMRS port(s).

The network device 110 then generates 420 DCI indicating the configuration. In some embodiments, for example, the network device 110 may indicate the configuration in a field for antenna port(s) in the DCI, for example, based on a predefined DMRS table. The network device 110 then transmits 430 the generated DCI to the terminal device 120 via at least one of the TRPs 130.

In response to receiving DCI from at least one of the TRPs 130, the terminal device 120 determines 440, from the DCI, the configuration for DMRS transmission between the TRPs 130 and the terminal device 120. In some embodiments, the terminal device 120 can determine the configuration based on the same predefined DMRS table as used by the network device 110. In some embodiments, for example, the terminal device 120 can determine, from the configuration, at least one of the following: DMRS port(s) to be used for the DMRS transmission, the number of DMRS CDM group(s) without data, the number of front-loaded DMRS symbols, respective numbers of DMRS CDM group(s) associated with different RS sets (different TRPs), the number of DMRS port(s), and respective indices for the DMRS port(s).

In some embodiments, DMRS transmissions can be performed between the TRPs 130 and the terminal device 120 based on the DMRS configuration. For example, in the case of UL DMRS transmission, the terminal device 120 may transmit DMRSs to the TRPs 130 on the allocated DMRS ports. Alternatively, or in addition, in the case of DL DMRS transmission, the network device 110 may transmit DMRSs via the TRPs 130 to the terminal device 120 on the allocated DMRS ports. The terminal device 120 may receive the DMRSs from the TRPs 130 on the allocated DMRS ports. Moreover, since the configuration also indicates the numbers of DMRS CDM groups associated with the different RS sets, the terminal device 120 may determine whether interference from another terminal device in communication with at least one of the plurality of TRPs is present. In response to determining that the interference from the other terminal device is present, the terminal device 120 may perform interference cancellation accordingly.

In this way, multi-user scheduling is enabled for multi-TRP transmission. Moreover, interference cancellation can be achieved more accurately. More details about the embodiments of the present disclosure will be discussed in the following with reference to further drawings.

In some embodiments, for DMRS type 1, if the terminal device 120 is configured with a plurality of DMRS ports from different CDM groups and the plurality of DMRS ports are associated with different TCI/QCL RS sets, respective numbers of DMRS CDM group(s) associated with different RS sets (that is, different TRPs) may be indicated to the terminal device 120.

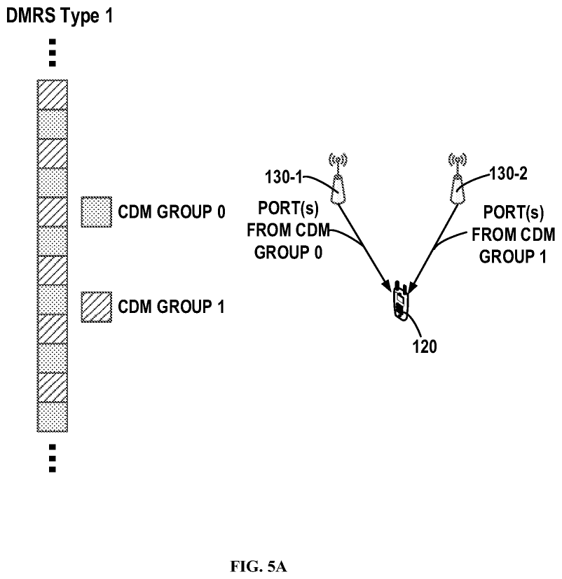

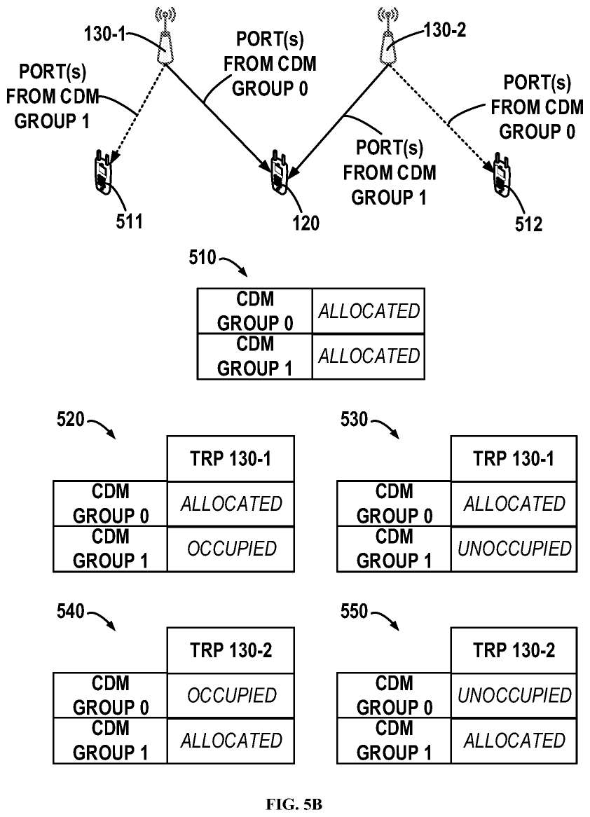

FIGS. 5A-5B show an example for DMRS type 1 in accordance with some embodiments of the present disclosure. As shown in FIG. 5A, the terminal device 120 is configured with DMRS ports from CDM groups 0 and 1 for DL DMRS transmission, in which DMRS port(s) coming from CDM group 0 are associated with the TRP 130-1 and DMRS port(s) coming from CDM group 1 are associated with the TRP 310-2. For example, the number of DMRS CDM group(s) without data is 2. In this event, from the perspective of the terminal device 120, both CDM group 0 and CDM group 1 are allocated to the terminal device 120. The statuses of CDM groups 0 and 1 from the perspective of the terminal device 120 are shown in Table 510 of FIG. 5B.

However, for different TRPs 130, the statuses of each CDM group may be different. For example, as shown in FIG. 5B, DMRS port(s) from CDM group 1 on the TRP 130-1 may be scheduled for DMRS transmission from the TRP 130-1 to another terminal device 511. DMRS port(s) from CDM group 0 on the TRP 130-2 may be scheduled for DMRS transmission from the TRP 130-2 to another terminal device 512. In different scenarios, the statuses of CDM group 0 and CDM group 1 are different. For example, from the perspective of the TRP 130-1, if DMRS port(s) from CDM group 1 on the TRP 130-1 are scheduled for DMRS transmission from the TRP 130-1 to the terminal device 511, the statuses of CDM group 0 and CDM group 1 on the TRP 130-1 are as shown in Table 520, where the status “ALLOCATED” means the CDM group on the TRP 130-1 is allocated to the terminal device 120, and the status “OCCUPIED” means the CDM group on the TRP 130-1 is not allocated to the terminal device 120 but occupied by another terminal device. If DMRS port(s) from CDM group 1 on the TRP 130-1 are not scheduled for DMRS transmission from the TRP 130-1 to another terminal device, the statuses of CDM group 0 and CDM group 1 on the TRP 130-1 are as shown in Table 530, where the status “ALLOCATED” means the CDM group on the TRP 130-1 is allocated to the terminal device 120, and the status “UNOCCUPIED” means the CDM group on the TRP 130-1 is neither allocated to the terminal device 120 nor occupied by another terminal device. Similarly, from the perspective of the TRP 130-2, if DMRS port(s) from CDM group 0 on the TRP 130-2 are scheduled for DMRS transmission from the TRP 130-2 to the terminal device 512, the statuses of CDM group 0 and CDM group 1 on the TRP 130-2 are as shown in Table 530. Otherwise, if DMRS port(s) from CDM group 0 on the TRP 130-2 are not scheduled for DMRS transmission from the TRP 130-2 to the terminal device 512, the statuses of CDM group 0 and CDM group 1 on the TRP 130-2 are as shown in Table 540.

In some embodiments, in order to indicate respective numbers of DMRS CDM group(s) associated with different RS sets (that is, different TRPs) to the terminal device 120, new DMRS tables can be defined according to the above different scenarios. Table 3 show an example DMRS table according to some embodiments of the present disclosure, in which the configured number of codewords is 1. In Table 3, for example, the value “x” indicates a scenario in which the number of DMRS CDM group(s) without data is 2 and both of the two CDM groups allocated to the terminal device 120 are not occupied by other terminal devices. For example, the value “x+1” or “x+2” indicates a scenario in which the number of DMRS CDM group(s) without data is 2 and one of the two CDM groups allocated to the terminal device 120 is occupied by another terminal device. For example, the value “x+3” indicates a scenario in which the number of DMRS CDM group(s) without data is 2 and both of the two CDM groups allocated to the terminal device 120 are occupied by other terminal devices.

TABLE 3
One Codeword:
Codeword 0 enabled,
Codeword 1 disabled

| | | Number of | Number of | | |
|---|---|---|---|---|---|
| | Number | occupied | occupied | | |
| | of DMRS | DMRS | DMRS | | |
| | CDM | CDM | CDM | | |
| | group(s) | group(s) for | group(s) | | Number of |
| | without | TCI RS set | for TCI RS | | front-load |
| Value | data | 1 | set 2 | DMRS port(s) | symbols |
| x | 2 | 1 | 1 | DMRS ports from two CDM | 1 |
| | | | | groups, e.g., DMRS ports 0, 2 | |
| x + 1 | 2 | 1 | 2 | DMRS ports from two CDM | 1 |
| | | | | groups, e.g., DMRS ports 0, 2 | |
| x + 2 | 2 | 2 | 1 | DMRS ports from two CDM | 1 |
| | | | | groups, e.g., DMRS ports 0, 2 | |
| x + 3 | 2 | 2 | 2 | DMRS ports from two CDM | 1 |
| | | | | groups, e.g., DMRS ports 0, 2 | |

Table 4 shows an example DMRS table according to some embodiments of the present disclosure, in which the configured number of codewords is 2. In Table 4, for example, the value “y” indicates a scenario in which both of the two CDM groups allocated to the terminal device 120 are not occupied by other terminal devices. For example, the value “y+1” or “y+2” indicates a scenario in which one of the two CDM groups allocated to the terminal device 120 is occupied by another terminal device. For example, the value “y+3” indicates a scenario in which both of the two CDM groups allocated to the terminal device 120 are occupied by other terminal devices.

TABLE 4
Two Codewords:
Codeword 0 enabled,
Codeword 1 enabled

| | | Number of | Number of | | |
|---|---|---|---|---|---|
| | Number | occupied | occupied | | |
| | of DMRS | DMRS | DMRS | | |
| | CDM | CDM | CDM | | |
| | group(s) | group(s) for | group(s) | | Number of |
| | without | TCI RS set | for TCI RS | | front-load |
| Value | data | 1 | set 2 | DMRS port(s) | symbols |
| y | 2 | 1 | 1 | DMRS ports from two CDM | 2 |
| | | | | groups, e.g., DMRS ports 0-4 | |
| y + 1 | 2 | 1 | 2 | DMRS ports from two CDM | 2 |
| | | | | groups, e.g., DMRS ports 0-4 | |
| y + 2 | 2 | 2 | 1 | DMRS ports from two CDM | 2 |
| | | | | groups, e.g., DMRS ports 0-4 | |
| y + 3 | 2 | 2 | 2 | DMRS ports from two CDM | 2 |
| | | | | groups, e.g., DMRS ports 0-4 | |

In some embodiments, for DMRS type 2, if the terminal device 120 is configured with a plurality of DMRS ports from different CDM groups and the plurality of DMRS ports are associated with different TCI/QCL RS sets, respective numbers of DMRS CDM group(s) associated with different RS sets (that is, different TRPs) may be indicated to the terminal device 120.

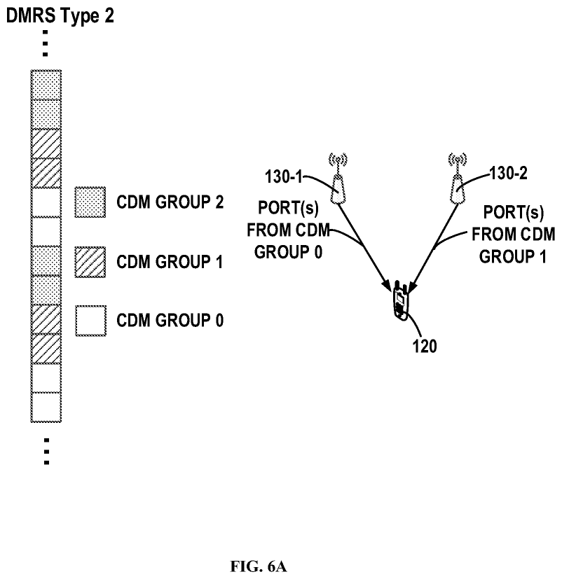

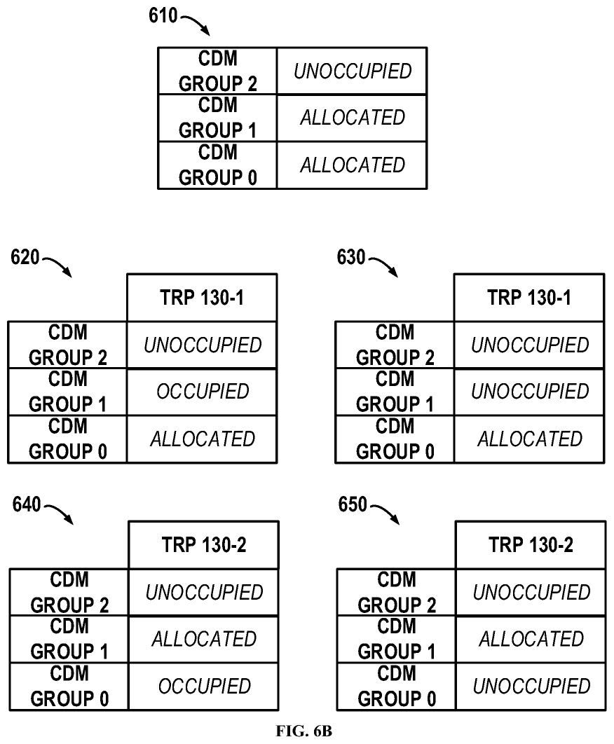

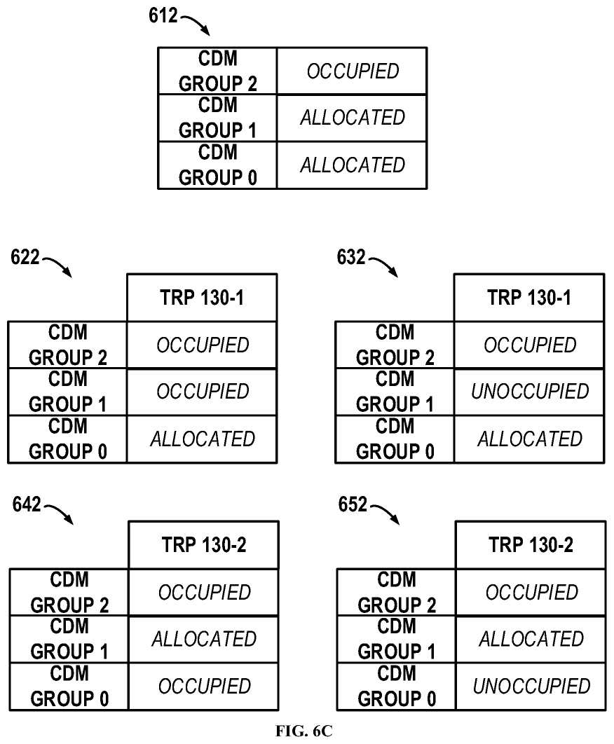

FIGS. 6A-6B show examples for DMRS type 2 in accordance with some embodiments of the present disclosure. As shown in FIG. 6A, the terminal device 120 is configured with DMRS ports from CDM groups 0 and 1 for DL DMRS transmission, in which DMRS port(s) coming from CDM group 0 are associated with the TRP 130-1 and DMRS port(s) coming from CDM group 1 are associated with the TRP 310-2.

In some embodiments, in the scenario as shown in FIG. 6A, the number of DMRS CDM group(s) without data is 2. In this event, from the perspective of the terminal device 120, both CDM group 0 and CDM group 1 are allocated to the terminal device 120, while CDM group 2 is not occupied by the terminal device 120. The statuses of CDM groups 0, 1 and 2 from the perspective of the terminal device 120 are shown in Table 610 of FIG. 6B. However, for different TRPs 130, the statuses of each CDM group may be different. The possible statuses of different CDM groups from the perspective of the TRP 130-1 are shown in Tables 620 and 630 of FIG. 6B. The possible statuses of different CDM groups from the perspective of the TRP 130-2 are shown in Tables 640 and 650 of FIG. 6B.

Alternatively, in some embodiments, in the scenario as shown in FIG. 6A, the number of DMRS CDM group(s) without data is 3. In this event, from the perspective of the terminal device 120, both CDM group 0 and CDM group 1 are allocated to the terminal device 120, while CDM group 2 is also occupied. The statuses of CDM groups 0, 1 and 2 from the perspective of the terminal device 120 are shown in Table 612 of FIG. 6C. However, for different TRPs 130, the statuses of each CDM group may be different. The possible statuses of different CDM groups from the perspective of the TRP 130-1 are shown in Tables 622 and 632 of FIG. 6C. The possible statuses of different CDM groups from the perspective of the TRP 130-2 are shown in Tables 642 and 652 of FIG. 6C.

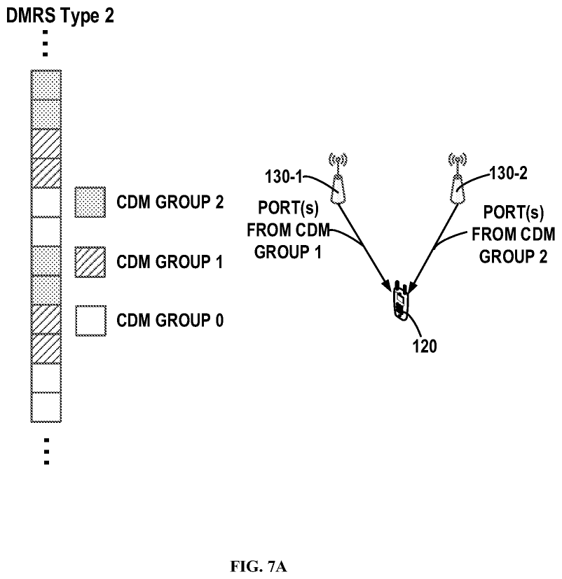

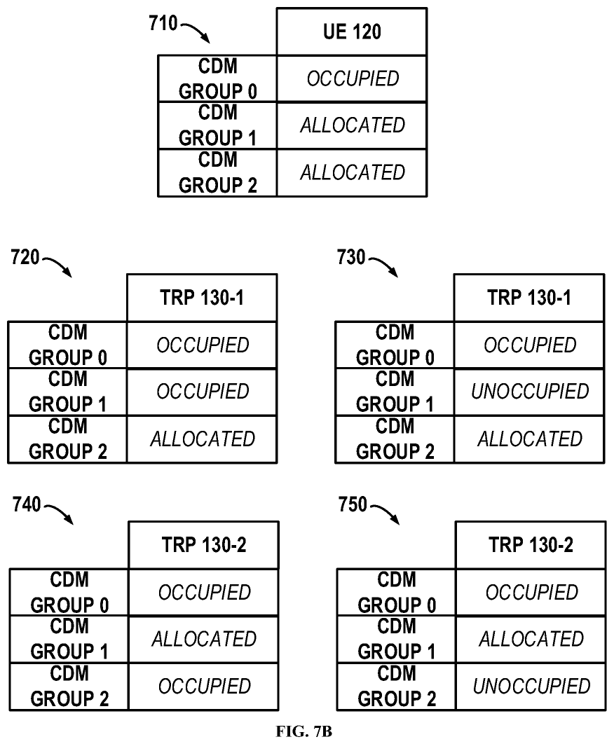

FIGS. 7A-7B show examples for DMRS type 2 in accordance with some embodiments of the present disclosure. As shown in FIG. 7A, the terminal device 120 is configured with DMRS ports from CDM groups 1 and 2 for DL DMRS transmission, in which DMRS port(s) coming from CDM group 1 are associated with the TRP 130-1 and DMRS port(s) coming from CDM group 2 are associated with the TRP 310-2.

In some embodiments, in the scenario as shown in FIG. 7A, the number of DMRS CDM group(s) without data is 3. In this event, from the perspective of the terminal device 120, both CDM group 1 and CDM group 2 are allocated to the terminal device 120, while CDM group 0 is also occupied. The statuses of CDM groups 0, 1 and 2 from the perspective of the terminal device 120 are shown in Table 710 of FIG. 7B. However, for different TRPs 130, the statuses of each CDM group may be different. The possible statuses of different CDM groups from the perspective of the TRP 130-1 are shown in Tables 720 and 730 of FIG. 7B. The possible statuses of different CDM groups from the perspective of the TRP 130-2 are shown in Tables 740 and 750 of FIG. 7B.

In some embodiments, in order to indicate respective numbers of DMRS CDM group(s) associated with different RS sets (that is, different TRPs) to the terminal device 120, new DMRS tables can be defined according to the above different scenarios. Table 5 show an example DMRS table according to some embodiments of the present disclosure, in which the configured number of codewords is 1. In Table 5, for example, the value “x” indicates a scenario in which the number of DMRS CDM group(s) without data is 2 and both of two CDM groups allocated to the terminal device 120 are not occupied by other terminal devices. For example, the value “x+1” or “x+2” indicates a scenario in which the number of DMRS CDM group(s) without data is 2 and one of the two CDM groups allocated to the terminal device 120 is occupied by another terminal device. For example, the value “x+3” indicates a scenario in which the number of DMRS CDM group(s) without data is 2 and both of the two CDM groups allocated to the terminal device 120 are occupied by other terminal devices. For example, the value “y” indicates a scenario in which the number of DMRS CDM group(s) without data is 3 and both of two CDM groups allocated to the terminal device 120 are not occupied by other terminal devices. For example, the value “y+1” or “y+2” indicates a scenario in which the number of DMRS CDM group(s) without data is 3 and one of the two CDM groups allocated to the terminal device 120 is occupied by another terminal device. For example, the value “y+3” indicates a scenario in which the number of DMRS CDM group(s) without data is 3 and both of the two CDM groups allocated to the terminal device 120 are occupied by other terminal devices.

TABLE 5
One Codeword:
Codeword 0 enabled,
Codeword 1 disabled

| | | Number of | Number of | | |
|---|---|---|---|---|---|
| | Number | occupied | occupied | | |
| | of DMRS | DMRS | DMRS | | |
| | CDM | CDM | CDM | | Number |
| | group(s) | group(s) for | group(s) | | of |
| | without | TCI RS set | for TCI RS | | front-load |
| Value | data | 1 | set 2 | DMRS port(s) | symbols |
| x | 2 | 1 | 1 | DMRS ports from CDM groups 0 | 2 |
| | | | | and 1, e.g., DMRS ports 0, 1, 2 | |
| x + 1 | 2 | 1 | 2 | DMRS ports from CDM groups 0 | 2 |
| | | | | and 1, e.g., DMRS ports 0, 1, 2 | |
| x + 2 | 2 | 2 | 1 | DMRS ports from CDM groups 0 | 2 |
| | | | | and 1, e.g., DMRS ports 0, 1, 2 | |
| x + 3 | 2 | 2 | 2 | DMRS ports from CDM groups 0 | 2 |
| | | | | and 1, e.g., DMRS ports 0, 1, 2 | |
| . . . | . . . | . . . | . . . | . . . | . . . |
| y | 3 | 2 | 2 | DMRS ports from CDM groups 0 | 2 |
| | | | | and 1, e.g., DMRS ports 0, 1, 2 | |
| y + 1 | 3 | 2 | 3 | DMRS ports from CDM groups 0 | 2 |
| | | | | and 1, e.g., DMRS ports 0, 1, 2 | |
| y + 2 | 3 | 3 | 2 | DMRS ports from CDM groups 0 | 2 |
| | | | | and 1, e.g., DMRS ports 0, 1, 2 | |
| y + 3 | 3 | 3 | 3 | DMRS ports from CDM groups 0 | 2 |
| | | | | and 1, e.g., DMRS ports 0, 1, 2 | |

In some embodiments, in order to indicate respective numbers of DMRS CDM group(s) associated with different RS sets (that is, different TRPs) to the terminal device 120, new DMRS tables can be defined according to the above different scenarios. Table 6 show an example DMRS table according to some embodiments of the present disclosure, in which the configured number of codewords is 1. In Table 6, for example, the value “x” indicates a scenario in which the number of DMRS CDM group(s) without data is 2 and both of two CDM groups allocated to the terminal device 120 are not occupied by other terminal devices. For example, the value “x+1” or “x+2” indicates a scenario in which the number of DMRS CDM group(s) without data is 2 and one of the two CDM groups allocated to the terminal device 120 is occupied by another terminal device. For example, the value “x+3” indicates a scenario in which the number of DMRS CDM group(s) without data is 2 and both of the two CDM groups allocated to the terminal device 120 are occupied by other terminal devices. For example, the value “y” indicates a scenario in which the number of DMRS CDM group(s) without data is 3 and both of two CDM groups allocated to the terminal device 120 are not occupied by other terminal devices. For example, the value “y+1” or “y+2” indicates a scenario in which the number of DMRS CDM group(s) without data is 3 and one of the two CDM groups allocated to the terminal device 120 is occupied by another terminal device. For example, the value “y+3” indicates a scenario in which the number of DMRS CDM group(s) without data is 3 and both of the two CDM groups allocated to the terminal device 120 are occupied by other terminal devices.

In some cases, DMRS ports in different orders or different groups may be configured for different TPRs, especially for non-ideal backhaul. For example, in the network 100 as shown in FIG. 1B, for DMRS type 1, DMRS ports 0, 1, 4 or 5 coming from CDM group 0 may be semi-statically configured for the TRP 130-1, while DMRS ports 2, 3, 6 or 7 coming from CDM group 1 may be semi-statically configured for the TRP 130-2. In this case, the DMRS table for the TRPs 130-1 may be different from that for the TRP 130-2. For example, if the number of DMRS CDM groups without data is 1, the CDM group to be used by the TRP 130-1 may be CDM group 0, while the CDM group to be used by the TRP 130-2 may be CDM group 1. Due to the different CDM groups configured for different TRPs, different assumptions about DMRS port indexes need to be applied for different TRPs.

In some embodiments, a set of parameters for DMRS configuration may be configured for the terminal device 120. The set of parameters may include at least one of the maximum number/length of the symbols for DMRS, a type of DMRS, index(es) of DMRS ports, number of DMRS ports, number of DMRS CDM group(s) without data and etc. For example, the set of parameters may be configured by signaling in Radio Resource Control (RRC), Medium Access Control (MAC) and/or Physical Layer (PHY).

In some embodiments, DMRS ports in different orders or different groups may be configured for different TPRs. In some embodiments, in the DMRS indication table including one or more DMRS configurations, the number of DMRS CDM group(s) without data may be indicated for each DMRS configuration. In some embodiments, for different DMRS configurations (for example, the DMRS configuration may be at least one of DMRS group configuration, DMRS ports order configuration), for a given DMRS port(s) configuration, the available value of number of DMRS CDM group(s) without data may be different. For example, in current 3GPP specifications, for DMRS type 1, if the indicated DMRS port(s) are only from CDM group 0, the number of DMRS CDM group(s) without data may be 1 or 21 If the indicated DMRS port(s) are only from CDM group 1, the number of DMRS CDM group(s) without data can only be 2. If the indicated DMRS port(s) are from CDM group 0 and CDM group 1, the number of DMRS CDM group(s) without data can only be 2. As another example, in current 3GPP specifications, for DMRS type 2, if the indicated DMRS port(s) are only from CDM group 0, the number of DMRS CDM group(s) without data may be 1, 2 or 3. If the indicated DMRS port(s) are only from CDM group 1, the number of DMRS CDM group(s) without data may be 2 or 3. If the indicated DMRS port(s) are only from CDM group 2, the number of DMRS CDM group(s) without data can only be 3. If the indicated DMRS port(s) are from CDM group 0 and CDM group 1, the number of DMRS CDM group(s) without data may be 2 or 3. If the indicated DMRS port(s) are from CDM group 1 and CDM group 2, the number of DMRS CDM group(s) without data can only be 3. If the indicated DMRS port(s) are from CDM group 0 and CDM group 1 and CDM group 2, the number of DMRS CDM group(s) without data can only be 3.

In some embodiments, if a specific DMRS configuration is configured, for example, a specific DMRS group, a specific order of DMRS port index, a DMRS group related to an additional TCI or an additional QCL RS set and/or a specific DMRS configuration indicator, the available number of DMRS CDM group(s) without data may be different. In some embodiments, the DMRS type may be configured as DMRS type 1 for terminal device 120. For example, if the indicated DMRS port(s) are only from CDM group 0, the number of DMRS CDM group(s) without data can only be 2. As another example, if the indicated DMRS port(s) are only from CDM group 1, the number of DMRS CDM group(s) without data may be 1 or 2. As another example, if the indicated DMRS port(s) are from CDM group 0 and CDM group 1, the number of DMRS CDM group(s) without data may only be 2.

In some embodiments, if the DMRS type in DMRS configuration parameters is configured as DMRS type 1 for the terminal device 120, in response to receiving PDSCH, the terminal device 120 may assume that the CDM groups indicated in the configured index from DMRS configuration table contain potential co-scheduled downlink DMRS and are not used for data transmission, where “1” and “2” for the number of DMRS CDM group(s) in DMRS configuration table correspond to CDM group 1, {1, 0}, respectively.

In some embodiments, if the DMRS type in DMRS configuration parameters is configured as DMRS type 2 for the terminal device 120, in response to receiving PDSCH, the terminal device 120 may assume that the CDM groups indicated in the configured index from DMRS configuration table contain potential co-scheduled downlink DMRS and are not used for data transmission, where “1”, “2” and “3” for the number of DMRS CDM group(s) in DMRS configuration table correspond to CDM group 1, {1,0}, {1,0,2}, respectively. In some embodiments, the DMRS type may be configured as DMRS type 2 for the terminal device 120. For example, if the indicated DMRS port(s) are only from CDM group 0, the number of DMRS CDM group(s) without data may be 2 or 3. As another example, if the indicated DMRS port(s) are only from CDM group 1, the number of DMRS CDM group(s) without data may be 1, 2 or 3. As another example, if the indicated DMRS port(s) are only from CDM group 2, the number of DMRS CDM group(s) without data can only be 3. As another example, if the indicated DMRS port(s) are from CDM group 0 and CDM group 1, the number of DMRS CDM group(s) without data may be 2 or 3. As another example, if the indicated DMRS port(s) are from CDM group 1 and CDM group 2, the number of DMRS CDM group(s) without data may be 2 or 3. As another example, in the DMRS configuration table, there may be no configuration with the indicated DMRS port(s) from CDM group 1 and CDM group 2. As another example, in the DMRS configuration table, there may be configurations with the indicated DMRS port(s) from CDM group 0 and CDM group 2. As another example, if the indicated DMRS port(s) are from CDM group 0 and CDM group 2, the number of DMRS CDM group(s) without data can only be 3. As another example, if the indicated DMRS port(s) are from CDM group 0 and CDM group 1 and CDM group 2, the number of DMRS CDM group(s) without data can only be 3.

In some embodiments, if the DMRS type in DMRS configuration parameters is configured as DMRS type 2 for the terminal device 120, in response to receiving PDSCH, the terminal device 120 may assume that the CDM groups indicated in the configured index from DMRS configuration table contain potential co-scheduled downlink DMRS and are not used for data transmission, where “1”, “2” and “3” for the number of DMRS CDM group(s) in DMRS configuration table correspond to CDM group 2, {2,1}, {2,1,0}, respectively. In some embodiments, the DMRS type may be configured as DMRS type 2 for the terminal device 120. For example, if the indicated DMRS port(s) are only from CDM group 0, the number of DMRS CDM group(s) without data can only be 3. As another example, if the indicated DMRS port(s) are only from CDM group 1, the number of DMRS CDM group(s) without data may be 2 or 3. As another example, if the indicated DMRS port(s) are only from CDM group 2, the number of DMRS CDM group(s) without data may be 1 or 2 or 3. As another example, if the indicated DMRS port(s) are from CDM group 0 and CDM group 1, the number of DMRS CDM group(s) without data can only be 3. As another example, if the indicated DMRS port(s) are from CDM group 1 and CDM group 2, the number of DMRS CDM group(s) without data may be 2 or 3. As another example, in the DMRS configuration table, there may be no configuration with the indicated DMRS port(s) from CDM group 0 and CDM group 2. As another example, if the indicated DMRS port(s) are from CDM group 0 and CDM group 1 and CDM group 2, the number of DMRS CDM group(s) without data can only be 3.

In some embodiments, if the DMRS type in DMRS configuration parameters is configured as DMRS type 2 for the terminal device 120, in response to receiving PDSCH, the terminal device 120 may assume that the CDM groups indicated in the configured index from DMRS configuration table contain potential co-scheduled downlink DMRS and are not used for data transmission, where “1”, “2” and “3” for the number of DMRS CDM group(s) in DMRS configuration table correspond to CDM group 1, {1,2}, {1,2,0}, respectively. In some embodiments, the DMRS type may be configured as DMRS type 2 for the terminal device 120. For example, if the indicated DMRS port(s) are only from CDM group 0, the number of DMRS CDM group(s) without data can only be 3. As another example, if the indicated DMRS port(s) are only from CDM group 1, the number of DMRS CDM group(s) without data may be 1 or 2 or 3. As another example, if the indicated DMRS port(s) are only from CDM group 2, the number of DMRS CDM group(s) without data may be 2 or 3. As another example, if the indicated DMRS port(s) are from CDM group 1 and CDM group 2, the number of DMRS CDM group(s) without data may be 2 or 3. As another example, if the indicated DMRS port(s) are from CDM group 0 and CDM group 1, the number of DMRS CDM group(s) without data can only be 3. As another example, in the DMRS configuration table, there may be no configuration with the indicated DMRS port(s) from CDM group 0 and CDM group 1. As another example, in the DMRS configuration table, there may be configuration with the indicated DMRS port(s) from CDM group 0 and CDM group 2. As another example, if the indicated DMRS port(s) are from CDM group 0 and CDM group 2, the number of DMRS CDM group(s) without data can only be 3. As another example, if the indicated DMRS port(s) are from CDM group 0 and CDM group 1 and CDM group 2, the number of DMRS CDM group(s) without data can only be 3.

In some embodiments, if the DMRS type in DMRS configuration parameters is configured as DMRS type 2 for the terminal device 120, in response to receiving PDSCH, the terminal device 120 may assume that the CDM groups indicated in the configured index from DMRS configuration table contain potential co-scheduled downlink DMRS and are not used for data transmission, where “1”, “2” and “3” for the number of DMRS CDM group(s) in DMRS configuration table correspond to CDM group 2, {2,0}, {2,0,1}, respectively. In some embodiments, the DMRS type may be configured as DMRS type 2 for the terminal device 120. For example, if the indicated DMRS port(s) are only from CDM group 0, the number of DMRS CDM group(s) without data may be 2 or 3. As another example, if the indicated DMRS port(s) are only from CDM group 1, the number of DMRS CDM group(s) without can only be 3. As another example, if the indicated DMRS port(s) are only from CDM group 2, the number of DMRS CDM group(s) without data may be 1 or 2 or 3. As another example, if the indicated DMRS port(s) are from CDM group 0 and CDM group 1, the number of DMRS CDM group(s) without data can only be 3. As another example, if the indicated DMRS port(s) are from CDM group 1 and CDM group 2, the number of DMRS CDM group(s) without data can only be 3. As another example, in the DMRS configuration table, there may be no configuration with the indicated DMRS port(s) from CDM group 1 and CDM group 2. As another example, in the DMRS configuration table, there may be configuration with the indicated DMRS port(s) from CDM group 0 and CDM group 2. As another example, if the indicated DMRS port(s) are from CDM group 0 and CDM group 2, the number of DMRS CDM group(s) without data may be 2 or 3. As another example, if the indicated DMRS port(s) are from CDM group 0 and CDM group 1 and CDM group 2, the number of DMRS CDM group(s) without data can only be 3.

In some embodiments, if there is an additional TCI or an additional QCL RS set configured for the terminal device 120, there may be a new DMRS configuration table to be used or new explanation for the current DMRS configuration table in 3GPP specifications. In some embodiments, if there is an additional TCI or an additional QCL RS set configured for the terminal device 120, there may be some new configurations to be included in the DMRS configuration table. In some embodiments, there may be at least one configuration indicating 4 DMRS ports from two CDM groups, in which one DMRS port is from one CDM group, and three DMRS ports are from another CDM group. For example, for DMRS type 1, the 4 DMRS ports may be ports {0,1,4,2}, {0,2,3,6}, {0,1,4,3} or {1,2,3,6}. As another example, for DMRS type 2, the 4 DMRS ports may be ports {0,1,6,2}, {0,2,3,8}, {2,3,8,4} or {2,4,5,10}. In some embodiments, there may be at least one configuration indicating 5 DMRS ports from two CDM groups, in which one DMRS port is from one CDM group, and four DMRS ports are from another CDM group. For example, for DMRS type 1, the 5 DMRS ports may be port {0,1,4,5,2}, {0,2,3,6,7}, {0,1,4,5,3} or {1,2,3,6,7}. As another example, for DMRS type 2, the 5 DMRS ports may be ports {0,1,6,7,2}, {0,1,6,7,4}, {0,2,3,8,9}, {0,4,5,10,11}, {2,3,8,9,4}, {2,3,8,9,5} or {2,4,5,10,11}. In some embodiments, there may be at least one configuration indicating 6 DMRS ports from two CDM groups, in which two DMRS port are from one CDM group, and four DMRS ports are from another CDM group. For example, for DMRS type 1, the 6 DMRS ports may be ports {0,1,4,5,2,3}, {0,1,2,3,6,7}, {0,1,4,5,6,7} or {4,5,2,3,6,7}. As another example, for DMRS type 2, the 6 DMRS ports may be ports {0,1,6,7,2,3}, {0,1,6,7,4,5}, {0,1,2,3,8,9}, {0,1,4,5,10,11}, {2,3,8,9,4,5}, {2,3,8,9,10,11} or {2,3,4,5,10,11}. In some embodiments, there may be at least one configuration indicating 4 DMRS ports from three CDM groups, in which one DMRS port is from a first CDM group, one DMRS port is from a second CDM group, and two DMRS ports are from a third CDM group. In some embodiments, there may be at least one configuration indicating 5 DMRS ports from three CDM groups, where one DMRS port is from a first CDM group, two DMRS port are from a second CDM group, and two DMRS ports are from a third CDM group. In some embodiments, there may be at least one configuration indicating 5 DMRS ports from three CDM groups, in which one DMRS port is from a first CDM group, one DMRS port is from a second CDM group, and three DMRS ports are from a third CDM group. In some embodiments, there may be at least one configuration indicating 6 DMRS ports from three CDM groups, in which one DMRS port is from a first CDM group, one DMRS port is from a second CDM group, and four DMRS ports are from a third CDM group. In some embodiments, there may be at least one configuration indicating 6 DMRS ports from three CDM groups, where one DMRS port is from a first CDM group, two DMRS ports are from a second CDM group, and three DMRS ports are from a third CDM group.

In some embodiments, there may be two DMRS groups configured (for example, DMRS group 1 and DMRS group 2) for the terminal device 120, and there may be two TCI and/or QCL RS sets configured for the two DMRS groups. In this case, in the DMRS configuration table, there may be more than one (e.g. two) configurations indicating the same number of DMRS ports, the same indexes of DMRS ports, the same DMRS type, the same number of DMRS CDM group(s) without data and the same number of DMRS symbols. The more than one (e.g.) two configurations may indicate different TCI and/or QCL information for the two DMRS groups. For example, there may be two configurations. One configuration may indicate that a first TCI and/or first QCL RS set is related to the DMRS group 1 and a second TCI and/or QCL RS set is related to the DMRS group 2. In addition, the other configuration may indicate that the first TCI and/or first QCL RS set is related to the DMRS group 2, and the second TCI and/or QCL RS set is related to the DMRS group 1.

In some embodiments, there may be two DMRS groups configured (for example, DMRS group 1 and DMRS group 2) for the terminal device 120, and there may be two TCI and/or QCL RS sets configured for the two DMRS groups. In some embodiments, if the two TCI and/or QCL RS sets for the two DMRS groups are different, the initializations for DMRS sequence generation for the two DMRS groups may be the same. For example, even if different initializations may be configured for two different DMRS CDM groups, in response to the TCI and/or QCL RS sets for the two DMRS CDM groups being different, the initializations for DMRS sequence generation for the two DMRS groups can be fixed to a single one. For example, the fixed single one initialization may be the initialization configured for the DMRS CDM group with the lowest index. That is, the configuration for different initializations may be ignored.

Table 6 as below shows a DMRS table in current 3GPP specifications, in which the DMRS type is DMRS type 1 and the maximum number/length of DMRS is 1.

TABLE 6
Antenna port(s) (1000 + DMRS port),
dmrs-Type = 1, maxLength = 1
One Codeword:
Codeword 0 enabled,
Codeword 1 disabled

| | Number of DMRS | |
|---|---|---|
| | CDM group(s) | |
| Value | without data | DMRS port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

In some embodiments, if CDM group 0 is semi-statically configured for the TRP 130-1 and CDM group 1 is semi-statically configured for the TRP 130-2, the above Table 6 may only be applicable to the TRP 130-1. A different DMRS table with different DMRS port index(es) may be applicable to the TRP 130-2, as shown in Table 7 as below. It can be seen that, in Table 7, DMRS ports indicated by the value “0”, “1”, “2”, “9” or “11” are different from those in Table 6.

TABLE 7
Antenna port(s) (1000 + DMRS port),
dmrs-Type = 1, maxLength = 1
One Codeword:
Codeword 0 enabled,
Codeword 1 disabled

| | Number of DMRS | |
|---|---|---|
| | CDM group(s) | |
| Value | without data | DMRS port(s) |
| 0 | 1 | 2 |
| 1 | 1 | 3 |
| 2 | 1 | 2, 3 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 or |
| | | 1, 2, 3 |
| 10 | 2 | 0-3 |
| 11 | 2 | 0, 2 or |
| | | 1, 3 |
| 12-15 | Reserved | Reserved |

Table 8 as below shows a DMRS table in current 3GPP specifications, in which the DMRS type is DMRS type 2 and the maximum number/length of DMRS is 1.

TABLE 8
Antenna port(s) (1000 + DMRS port), dmrs-Type = 2, maxLength = 1

| One Codeword: | | | Two Codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS | | | DMRS | |
| | CDM | | | CDM | |
| | group(s) | | | group(s) | |
| | without | DMRS | | without | |
| Value | data | port(s) | Value | data | DMRS port(s) |
| 0 | 1 | 0 | 0 | 3 | 0-4 |
| 1 | 1 | 1 | 1 | 3 | 0-5 |
| 2 | 1 | 0, 1 | 2-31 | Reserved | Reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

In some embodiments, if CDM group 0 is semi-statically configured for the TRP 130-1 and CDM group 1 is semi-statically configured for the TRP 130-2, the above Table 8 may only be applicable to the TRP 130-1. A different DMRS table with different DMRS port index(es) may be applicable to the TRP 130-2, as shown in Table 9 as below. It can be seen that, in Table 9, DMRS ports indicated by the value “0”, “1”, “2”, “9”, “20”, “22” or “23” are different from those in Table 8.

TABLE 9
Antenna port(s) (1000 + DMRS port), dmrs-Type = 2, maxLength = 1

| One Codeword: | | | Two Codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS | | | DMRS | |
| | CDM | | | CDM | |
| | group(s) | | | group(s) | |
| | without | DMRS | | without | |
| Value | data | port(s) | Value | data | DMRS port(s) |
| 0 | 1 | 2 | 0 | 3 | 0-4 |
| 1 | 1 | 3 | 1 | 3 | 0-5 |
| 2 | 1 | 2, 3 | 2-31 | Reserved | Reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 or | | | |
| | | 1, 2, 3 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 or | | | |
| | | 1, 2, 3 | | | |
| 21 | 3 | 3-5 | | | |
| 22 | 3 | 0-3 or | | | |
| | | 2, 3, 4, 5 | | | |
| 23 | 2 | 0, 2 or | | | |
| | | 1, 3 | | | |
| 24-31 | Reserved | Reserved | | | |

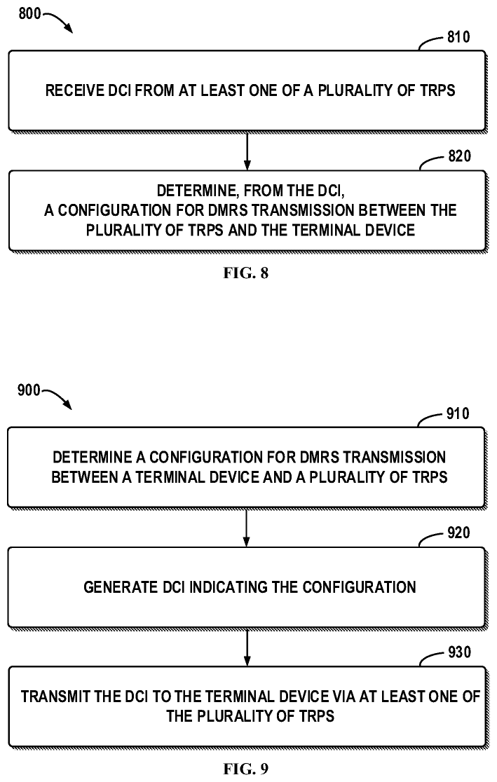

FIG. 8 shows a flowchart of an example method 800 in accordance with some embodiments of the present disclosure. The method 800 can be implemented at the terminal device 120 as shown in FIGS. 1A and 1B. It is to be understood that the method 800 may include additional blocks not shown and/or may omit some blocks as shown, and the scope of the present disclosure is not limited in this regard.

At block 810, the terminal device 120 receives DCI from at least one of a plurality of TRPs in communication with the terminal device, the plurality of TRPs being associated with different RS sets.

At block 820, the terminal device 120 determines, from the DCI, a configuration for DMRS transmission between the plurality of TRPs and the terminal device, wherein the configuration at least indicates one or more DMRS ports from a first number of DMRS CDM groups to be used for the DMRS transmission and respective numbers of DMRS CDM groups associated with the different RS sets.

In some embodiments, the DCI includes a field to indicate antenna ports for DMRS transmission, and the terminal device 120 determines the configuration by determining, from the field in the DCI, the one or more DMRS ports and the numbers of DMRS CDM groups associated with the different RS sets.

In some embodiments, the terminal device 120 performs the DMRS transmission between the plurality of TRPs and the terminal device based on the configuration.

In some embodiments, the DMRS transmission includes uplink transmission of DMRSs. The terminal device 120 performs the DMRS transmission by transmitting DMRSs to the plurality of TRPs on the one or more DMRS ports.

In some embodiments, the DMRS transmission includes downlink transmission of DMRSs. The terminal device 120 performs the DMRS transmission by receiving DMRSs transmitted from the plurality of TRPs on the one or more DMRS ports.

In some embodiments, the terminal device 120 determines, based on the numbers of DMRS CDM groups associated with the different RS sets, whether interference from another terminal device in communication with at least one of the plurality of TRPs is present. In response to determining that the interference from the other terminal device is present, the terminal device 120 cancels the interference.

FIG. 9 shows a flowchart of an example method 900 in accordance with some embodiments of the present disclosure. The method 900 can be implemented at the network device 110 as shown in FIGS. 1A and 1B. It is to be understood that the method 900 may include additional blocks not shown and/or may omit some blocks as shown, and the scope of the present disclosure is not limited in this regard.

At block 910, the network device 110 determines a configuration for DMRS transmission between a terminal device served by the network device and a plurality of TRPs in communication with the terminal device, wherein the plurality of TRPs are associated with different RS sets, and the configuration at least indicates one or more DMRS ports from a first number of DMRS CDM groups to be used for the DMRS transmission and respective numbers of DMRS CDM groups associated with the different RS sets.

At block 920, the network device 110 generates DCI indicating the configuration.

At block 930, the network device 110 transmits the DCI to the terminal device via at least one of the plurality of TRPs.

In some embodiments, the network device 110 generates the DCI by indicating, in a field of the DCI for indicating antenna ports for DMRS transmission, the configuration.

In some embodiments, the network device 110 performs the DMRS transmission between the plurality of TRPs and the terminal device based on the configuration.

In some embodiments, the DMRS transmission includes uplink transmission of DMRSs, and the network device 110 performs the DMRS transmission by receiving, via the plurality of TRPs, DMRSs transmitted from the terminal device on the one or more DMRS ports.

In some embodiments, the DMRS transmission includes downlink transmission of DMRSs, and the network device 110 performs the DMRS transmission by transmitting, via the plurality of TRPs, DMRSs to the terminal device on the one or more DMRS ports.

In some embodiments, the network device 110 causes the terminal device to cancel interference from another terminal device in communication with at least one of the plurality of TRPs based on the numbers of DMRS CDM groups associated with the different RS sets.

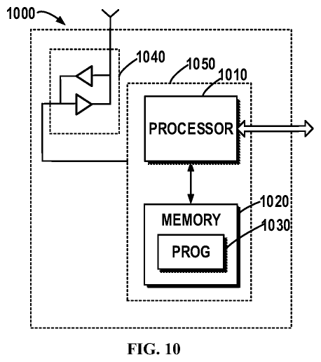

FIG. 10 is a simplified block diagram of a device 1000 that is suitable for implementing embodiments of the present disclosure. The device 1000 can be considered as a further example implementation of the network device 110, the TRP 130 or the terminal device 120 as shown in FIGS. 1A-1B. Accordingly, the device 1000 can be implemented at or as at least a part of the network device 110, the TRP 130 or the terminal device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 8 and/or 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method implemented at a terminal device, comprising:
receiving downlink control information (DCI) from at least one of a plurality of Transmission and Reception Points (TRPs) in communication with the terminal device, the plurality of TRPs being associated with different reference signal (RS) sets; and
determining, from the DCI, a configuration for Demodulation Reference Signal (DMRS) transmission between the plurality of TRPs and the terminal device,
wherein the configuration at least indicates one or more DMRS ports from a first number of DMRS CDM groups to be used for the DMRS transmission and respective numbers of DMRS CDM groups associated with the different RS sets.

2. The method of claim 1, wherein the DCI includes a field to indicate antenna ports for DMRS transmission, and determining the configuration comprises:
determining, from the field in the DCI, the one or more DMRS ports and the numbers of DMRS CDM groups associated with the different RS sets.

3. The method of claim 1, further comprising:
performing the DMRS transmission between the plurality of TRPs and the terminal device based on the configuration.

4. The method of claim 3, wherein the DMRS transmission includes uplink transmission of DMRSs, and performing the DMRS transmission comprises:
transmitting DMRSs to the plurality of TRPs on the one or more DMRS ports.

5. The method of claim 3, wherein the DMRS transmission includes downlink transmission of DMRSs, and performing the DMRS transmission comprises:
receiving DMRSs transmitted from the plurality of TRPs on the one or more DMRS ports.

6. The method of claim 5, further comprising:
determining, based on the numbers of DMRS CDM groups associated with the different RS sets, whether interference from another terminal device in communication with at least one of the plurality of TRPs is present; and
in response to determining that the interference from the other terminal device is present, cancelling the interference.

7. A method implemented at a network device, comprising:
determining a configuration for Demodulation Reference Signal (DMRS) transmission between a terminal device served by the network device and a plurality of Transmission and Reception Points (TRPs) in communication with the terminal device,
wherein the plurality of TRPs are associated with different reference signal (RS) sets, and the configuration at least indicates one or more DMRS ports from a first number of DMRS CDM groups to be used for the DMRS transmission and respective numbers of DMRS CDM groups associated with the different RS sets;
generating downlink control information (DCI) indicating the configuration; and
transmitting the DCI to the terminal device via at least one of the plurality of TRPs.

8. The method of claim 7, wherein generating the DCI comprises:
indicating, in a field of the DCI for indicating antenna ports for DMRS transmission, the configuration.

9. The method of claim 7, further comprising:
performing the DMRS transmission between the plurality of TRPs and the terminal device based on the configuration.

10. The method of claim 9, wherein the DMRS transmission includes uplink transmission of DMRSs, and performing the DMRS transmission comprises:
receiving, via the plurality of TRPs, DMRSs transmitted from the terminal device on the one or more DMRS ports.

11. The method of claim 9, wherein the DMRS transmission includes downlink transmission of DMRSs, and performing the DMRS transmission comprises:
transmitting, via the plurality of TRPs, DMRSs to the terminal device on the one or more DMRS ports.

12. The method of claim 11, further comprising:
causing the terminal device to cancel interference from another terminal device in communication with at least one of the plurality of TRPs based on the numbers of DMRS CDM groups associated with the different RS sets.

13. A terminal device comprising:
a processor; and
a memory coupled to the processor and storing instructions thereon, the instructions, when executed by the processor, causing the terminal device to perform actions comprising:
receiving downlink control information (DCI) from at least one of a plurality of Transmission and Reception Points (TRPs) in communication with the terminal device, the plurality of TRPs being associated with different reference signal (RS) sets; and
determining, from the DCI, a configuration for Demodulation Reference Signal (DMRS) transmission between the plurality of TRPs and the terminal device,
wherein the configuration at least indicates one or more DMRS ports from a first number of DMRS CDM groups to be used for the DMRS transmission and respective numbers of DMRS CDM groups associated with the different RS sets.

14. The terminal device of claim 13, wherein the DCI includes a field to indicate antenna ports for DMRS transmission, and determining the configuration comprises:
determining, from the field in the DCI, the one or more DMRS ports and the numbers of DMRS CDM groups associated with the different RS sets.

15. The terminal device of claim 13, wherein the actions further comprise:
performing the DMRS transmission between the plurality of TRPs and the terminal device based on the configuration.

16. The terminal device of claim 15, wherein the DMRS transmission includes uplink transmission of DMRSs, and performing the DMRS transmission comprises:
transmitting DMRSs to the plurality of TRPs on the one or more DMRS ports.

17. The terminal device of claim 15, wherein the DMRS transmission includes downlink transmission of DMRSs, and performing the DMRS transmission comprises:
receiving DMRSs transmitted from the plurality of TRPs on the one or more DMRS ports.

18. The terminal device of claim 17, wherein the actions further comprise:
determining, based on the numbers of DMRS CDM groups associated with the different RS sets, whether interference from another terminal device in communication with at least one of the plurality of TRPs is present; and
in response to determining that the interference from the other terminal device is present, cancelling the interference.

19-26. (canceled)
